(19) United States
(12) Patent Application Publication
(10) Pub. No.: US 2022/0171937 A1
(43) Pub. Date: Jun. 2, 2022

(54) DOCUMENT SENTENCE CONCEPT LABELING SYSTEM, TRAINING METHOD AND LABELING METHOD THEREOF

(71) Applicant: INDUSTRIAL TECHNOLOGY RESEARCH INSTITUTE, Hsinchu (TW)

(72) Inventors: Min-Hsin SHEN, Taichung City (TW); Yao-Chung FAN, Kaohsiung City (TW); Cheng-Yang JIANG, Taichung City (TW); Wen-Ping KUO, Kaohsiung City (TW)

(73) Assignee: INDUSTRIAL TECHNOLOGY RESEARCH INSTITUTE, Hsinchu (TW)

(21) Appl. No.: 17/137,592

(22) Filed: Dec. 30, 2020

(30) Foreign Application Priority Data
Nov. 30, 2020 (TW) 109142019

(51) Int. Cl. G06F 40/289; G06F 40/131; G06F 40/284

(52) U.S. Cl. CPC G06F 40/289; G06F 40/284; G06F 40/131

(57) ABSTRACT

A document sentence concept labeling system, a training method and a labeling method thereof are provided. The labeling method of the document sentence concept labeling system includes the following steps. An unlabeled document and one or more sentence concepts are inputted to a pre-trained language model to obtain a set of word embeddings of the unlabeled document. The set of word embeddings of the unlabeled document is inputted into a document analysis model to obtain a start position and an end position of a sentence set corresponding to each of the sentence concepts in the unlabeled document. According to each of the start positions and each of the end positions, each of the sentence sets is obtained.

This application claims the benefit of Taiwan application Serial No. 109142019, filed Nov. 30, 2020, the disclosure of which is incorporated by reference herein in its entirety.

### TECHNICAL FIELD

The disclosure relates in general to a document sentence concept labeling system, a training method and a labeling method thereof.

### BACKGROUND

Document structure analysis is an important technology for deep document understanding and information extraction. The document structure analysis expands the scope of document analysis from the level of words and named entities to the level of larger contexts such as multiple sentences. This analysis includes dividing the full text of a document into smaller blocks, and giving different blocks corresponding category labels. For example, the sentences in the abstracts of biomedical scientific papers may be automatically divided and labeled with different sentence concepts, such as background, purpose, method, conclusion, and contribution.

After a document is labeled, the sentence sets corresponding to different sentence concepts can be obtained, and the result can be used as a feature information for higher-level applications. In practical use, the labeling accuracy is not easy to improve when the structures of the documents have great variation.

### SUMMARY

The disclosure is directed to a document sentence concept labeling system, a training method and a labeling method thereof.

According to one embodiment, a training method of a document sentence concept labeling system is provided. The training method of the document sentence concept labeling system includes the following steps. A plurality of labeled documents, each of which is labeled one or more sentence sets corresponding to one or more sentence concepts are received. A start position and an end position of each of the sentence sets are generated in each of the labeled documents. Orders of the sentence sets in each of the labeled documents are changed and the start positions and the end positions in each of the labeled documents are updated, to obtain a plurality of generated documents, each of which is labeled the sentence sets. Each of the generated documents is inputted into a pre-trained language model to obtain a set of word embeddings of each of the generated documents. The sets of word embeddings, the start positions and the end positions of the generated documents are inputted into a document analysis model for performing a training procedure of the document analysis model. The document analysis model is used to label the sentence concepts in an unlabeled document.

According to another embodiment, a labeling method of a document sentence concept labeling system is provided. The labeling method of the document sentence concept labeling system includes the following steps. An unlabeled document and one or more sentence concepts are inputted into a pre-trained language model to obtain a set of word embeddings of the unlabeled document. The set of word embeddings of the unlabeled document is inputted into a document analysis model to obtain a start position and an end position of a sentence set corresponding to each of the sentence concepts in the unlabeled document. Each of the sentence sets is obtained according to each of the start positions and each of the end positions.

According to an alternative embodiment, a document sentence concept labeling system is provided. The document sentence concept labeling system includes a position indexing unit, a data generation unit, a data generation unit, a pre-trained language model and a document analysis model. The position indexing unit is configured to receive a plurality of labeled documents, each of which is labeled one or more sentence sets corresponding to one or more sentence concepts. The position indexing unit generates a start position and an end position of each of the sentence sets in the labeled documents. The data generation unit is configured to change orders of the sentence sets in each of the labeled documents, and update the start positions and the end positions in each of the labeled documents to obtain a plurality of generated documents, each of which is labeled the sentence sets. The pre-trained language model is configured to obtain a set of word embeddings of each of the generated documents. The document analysis model is configured to receive the sets of word embeddings, the start positions and the end positions of the generated documents, for performing a training procedure. The document analysis model is used to label the sentence concepts in an unlabeled document.

### BRIEF DESCRIPTION OF THE DRAWINGS

FIG. 1 shows a schematic diagram of an unlabeled document performed the document sentence concept labeling according to an embodiment.

FIGS. 2A to 2E illustrate the execution of a document sentence concept labeling system according to an embodiment.

FIG. 3 shows a block diagram of the document sentence concept labeling system according to an embodiment.

FIG. 4 shows a flowchart of a labeling method of the document sentence concept labeling system according to an embodiment.

FIG. 5 shows a flowchart of a training method of the document sentence concept labeling system according to an embodiment.

FIG. 6 illustrates a schematic diagram of the document sentence concept labeling system for relation extraction according to an embodiment.

FIG. 7 shows a schematic diagram of the document sentence concept labeling system for document retrieval according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

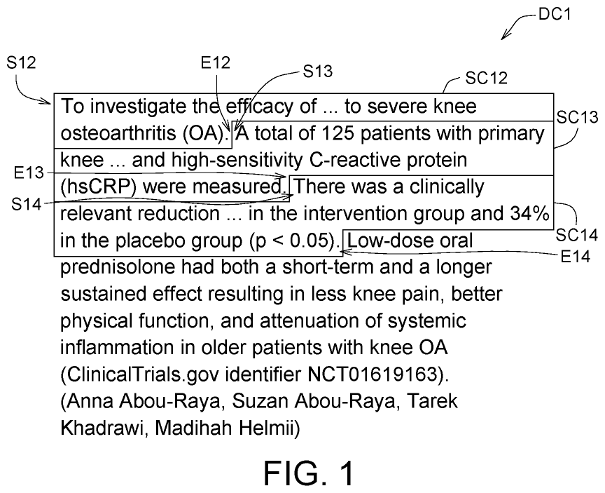

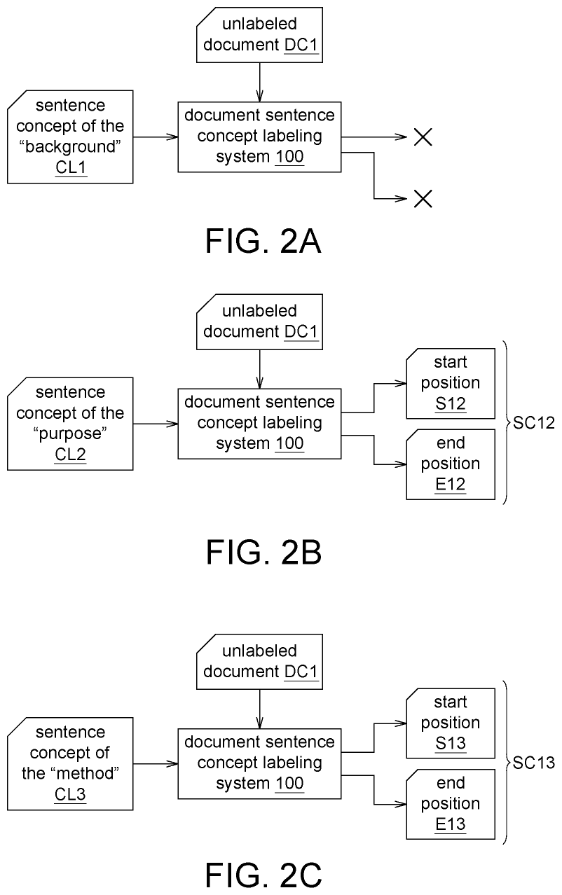

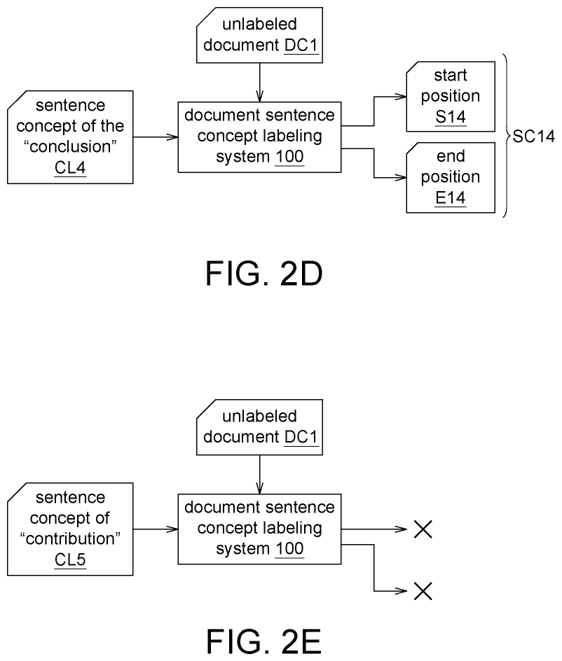

Please refer to FIGS. 1 to 2E. FIG. 1 shows a schematic diagram of an unlabeled document DC1 performed the document sentence concept labeling according to an embodiment. FIGS. 2A to 2E illustrate the execution of the document sentence concept labeling system 100 according to an embodiment. For example, for analyzing the document structure of the unlabeled document DC1, the document sentence concept labeling system 100 can label the sentence concept CL1 (shown in FIG. 2A) of “background”, the sentence concept CL2 (shown in FIG. 2B) of “purpose”, the sentence concept CL3 (shown in FIG. 2C) of “method”, the sentence concept CL4 (shown in FIG. 2D) of “conclusion”, the sentence concept CL5 (shown in FIG. 2E) of “Contribution”, etc.

As shown in FIGS. 1 and 2A, after the unlabeled document DC1 and the sentence concept CL1 of the “background” are inputted into the document sentence concept labeling system 100, the document sentence concept labeling system 100 does not find anything about the sentence concept CL1 of the “background”, so the sentence set of “background” cannot be labeled.

Then, as shown in FIGS. 1 and 2B, after the unlabeled document DC1 and the sentence concept CL2 of the “purpose” are inputted into the document sentence concept labeling system 100, the document sentence concept labeling system 100 can be labeled the sentence set SC12 with the “purpose”, that is, a start position (start token) S12 and an end position (end token) E12 of the sentence set SC12 can be labeled in the unlabeled document DC1.

Next, as shown in FIGS. 1 and 2C, after the unlabeled document DC1 and the sentence concept CL3 of the “method” are inputted into the document sentence concept labeling system 100, the document sentence concept labeling system 100 can label the sentence set SC13 with the “method”, that is, a start position S13 and an end position E13 of sentence set SC13 can be labeled in the unlabeled document DC1.

Then, as shown in FIGS. 1 and 2D, after the unlabeled document DC1 and the sentence concept CL4 of the “conclusion” are inputted into the document sentence concept labeling system 100, the document sentence concept labeling system 100 can label the sentence set SC14 with the “conclusion”, that is, a start position S14 and an end position E14 of the sentence set SC14 can be labeled in the unlabeled document DC1.

Afterwards, as shown in FIGS. 1 and 2E, after the unlabeled document DC1 and the sentence concept CL5 of “contribution” are inputted into the document sentence concept labeling system 100, the document sentence concept labeling system 100 does not find anything about the sentence concept CL5 of “contribution”, so the sentence set of “contribution” cannot be labeled.

In this embodiment, any of the sentence sets SC12, SC13, SC14 analyzed by the document sentence concept labeling system 100 may contain more than one sentence. Moreover, the content inputted into the document sentence concept labeling system 100 is not a single sentence, but the full text of the unlabeled document DC1. In addition, the document sentence concept labeling system 100 does not classify the sentence concept for individual sentence, but identifies the start positions S12, S13, S14 and the end positions E12, E13, E14 of the sentence sets SC12, SC13, SC14 from the entire unlabeled document DC1.

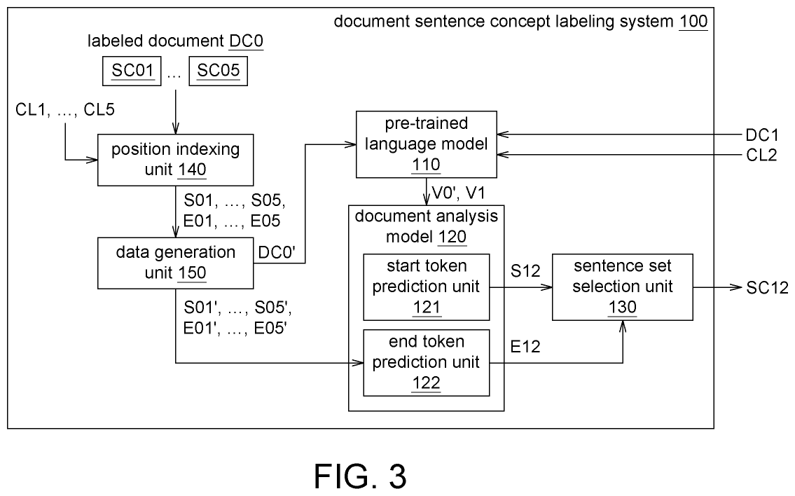

Please refer to FIG. 3, which shows a block diagram of the document sentence concept labeling system 100 according to an embodiment. The document sentence concept labeling system 100 includes a pre-trained language model 110, a document analysis model 120, a sentence set selection unit 130, a position indexing unit 140 and a data generation unit 150. The pre-trained language model 110, the document analysis model 120, the sentence set selection unit 130, the position indexing unit 140 and/or the data generation unit 150 are/is, for example, a circuit, a chip, a circuit board, or a storage device for storing program codes.

The document sentence concept labeling system 100 can use the pre-trained language model 110, the document analysis model 120 and the sentence set selection unit 130 to label the sentence set SC12 corresponding to the sentence concept CL2 in the unlabeled document DC1 (The same is true for the sentence sets SC13 and SC14. During labeling, only one sentence concept is labeled at a time. For clearly illustrating this point, only the sentence set SC12 corresponding to the sentence concept CL2 is taken as an example for illustration in FIG. 3). The following is a flowchart to explain in detail the operation of the above components in the labeling method.

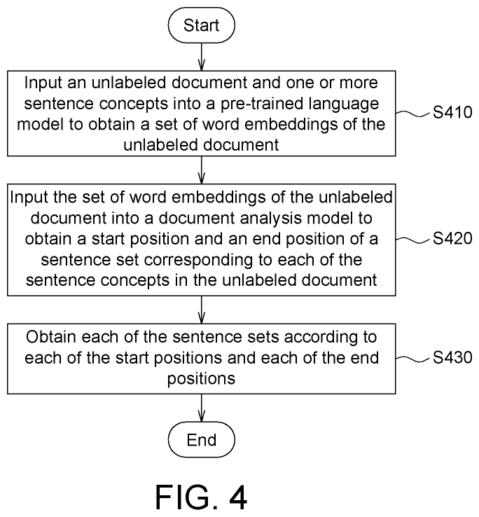

Please refer to FIGS. 3 and 4. FIG. 4 shows a flowchart of the labeling method of the document sentence concept labeling system 100 according to an embodiment. In step S410, the unlabeled document DC1 and one or more sentence concepts (e.g. the sentence concept CL2) are inputted into the pre-trained language model 110 to obtain the set of word embeddings V1 of the unlabeled document DC1. The pre-trained language model 110 is, for example, a Bidirectional Encoder Representations from Transformers (BERT) model, an ALBERT model, an XLNet model, a RoBERTa model, a DeBERTa model, or a compressed, a simplified or a pruned version of any of the above model. The pre-trained language model 110 can extract high-quality language features from text data.

Take the BERT model as an example. Generally, the input to the BERT model is a sentence with [CLS] and [SEP] as a special mark at the beginning and end, such as [CLS]sentence1[SEP] or [CLS]sentence1[SEP]sentence2[SEP] . . . [SEP]. Among them the sentence1 and the sentence2 are a sentence respectively.

In this embodiment, the input to the BERT model is the full text of the unlabeled document DC1 and the sentence concept CL2 (The same is true for sentence concepts CL3 and CL4. During labeling, only one sentence concept is labeled at a time. For clearly illustrating this point, only the sentence concept CL2 is taken as an example for illustration). The input for the BERT model is, for example, [CLS]label[SEP]text[SEP]. The label is one of sentence concepts CL1, CL2, . . . , CL5, and the text is the full text of the unlabeled document DC1.

Then, in step S420, the set of word embeddings V1 of the unlabeled document DC1 is inputted into the document analysis model 120 to obtain a start position (e.g. the start position S12) and an end position (e.g. the end position E12) of a sentence set (for example, the sentence set SC12) corresponding to each of the sentence concepts (for example, the sentence concept CL2) in the unlabeled document DC1. The document analysis model 120 includes a start token prediction unit 121 and an end token prediction unit 122. The start token prediction unit 121 is configured to predict the start position S12; the end token prediction unit 122 is configured to predict the end position E12. In this step, the document analysis model 120 contains a dense layer and a Softmax layer. The set of word embeddings V1 is inputted into the dense layer and the Softmax layer to generate the start position distribution probability and the end position distribution probability, and then the start position S12 and the end position E12 are obtained.

In this embodiment, the document analysis model 120 receives the set of word embeddings V1 generated from the full text of the unlabeled document DC1.

Next, in step S430, the sentence set selection unit 130 obtains each of the sentence sets (e.g. the sentence set SC12) corresponding to each of the sentence concepts (for example, the sentence concept CL2) according to each of the start positions (for example, the start position S12) and each of the end positions (for example, the end position E12).

In this embodiment, the labeling method of the document sentence concept labeling system 100 is performed based on analyzing the full text of the unlabeled document DC1. Subsequently, the range of the sentence set corresponding to the sentence concept is identified. It is not to perform the classification of a single sentence, so the sentence set SC12 that best fits the sentence concept CL2 can be found among all the sentences. Therefore, the labeling accuracy of the document sentence concept labeling system 100 can be greatly improved.

For example, please refer to Table 1 below. Compared with HSLN-CNN, HSLIN-RNN, AI2 and other labeling methods, the labeling method disclosed in this disclosure can achieve the highest accuracy (F1) in all three unlabeled documents.

TABLE I

| | Accuracy (%) | | |
|---|---|---|---|
| Labeling | Unlabeled | Unlabeled | Unlabeled |
| method | document I | document II | document III |
| HSLN-CNN | 92.2 | 92.8 | 84.7 |
| HSLIN-RNN | 92.6 | 93.9 | 84.3 |
| AI2 | 92.9 | 94.3 | 84.8 |
| This disclosure | 96.1 | 97.6 | 89.3 |

The above embodiment is taken the sentence concept CL2 as an example for illustration. The rest of the sentence concepts CL1, CL3, CL4, CL5 can also be labeled according to the above steps.

The above is the labeling method of the document sentence concept labeling system 100. Before implementing the labeling method, the document sentence concept labeling system 100 must be properly trained. Please refer to FIG. 3, the document sentence concept labeling system 100 can use the position indexing unit 140, the data generation unit 150, and the pre-trained language model 110 to train the document analysis model 120. The following is a flowchart to explain in detail the operation of the above components in the training method.

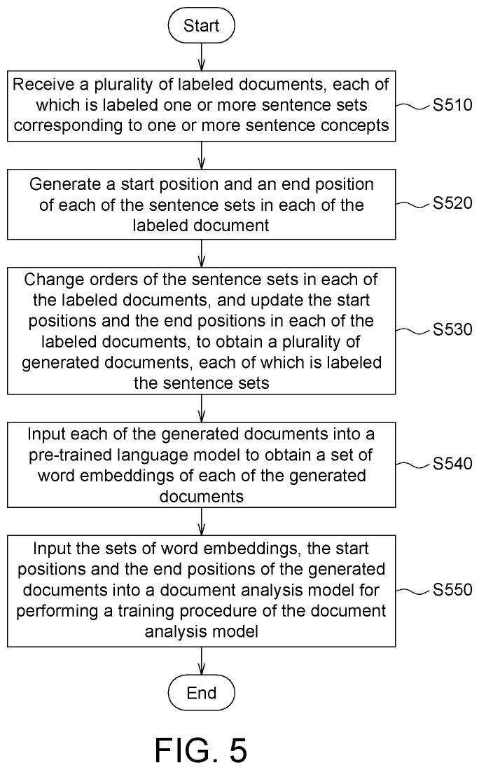

Please refer to FIGS. 3 and 5. FIG. 5 shows a flowchart of a training method of the document sentence concept labeling system 100 according to an embodiment. In step S510, a plurality of labeled documents DC0 are received by the position indexing unit 140. Each of the labeled documents DC0 has been labeled with one or more sentence sets SC01, . . . , SC05 corresponding to one or more sentence concepts CL1, CL5.

Next, in step S520, the position indexing unit 140 generates start positions S01, . . . , S05 and end positions E01, E05 of the sentence sets SC01, . . . , SC05 in the labeled documents DC0.

Next, in step S530, the data generation unit 150 changes the orders of the sentence sets SC01, . . . , SC05 in the labeled documents DC0, and updates the start positions S01, . . . , S05 and the end positions E01, . . . , E05 by the start positions S01′, . . . , S05′ and the end positions E01′, E05′ to obtain a plurality of generated documents DC0′. Each of the generated documents DC0′ is labeled with the sentence sets SC01, . . . , SC05. The generated documents DC0′ are no longer the original labeled documents DC0, but retain the sentence sets SC01, . . . , SC05.

Afterwards, in step S540, the generated documents DC0′ are inputted into the pre-trained language model 110 to obtain a plurality of sets of word embeddings V0′ of the generated documents DC0′.

Then, in step S550, the sets of word embeddings V0′ of the generated documents DC0′, the start positions S01′, . . . , S05′ and the end positions E01′, . . . , E05′ are inputted into the document analysis model 120 for performing a training procedure of the document analysis model 120. That is to say, when performing the training procedure, the labeled documents DC0 are not inputted into the document analysis model 120, but instead the generated documents DC0′ are inputted into the document analysis model 120. In the generated documents DC0′, the orders of sentence sets SC01, . . . , SC05 have been changed, and there is no order feature. Therefore, the document sentence concept labeling system 100 has a fairly high tolerance and robustness for various document structure variations.

For example, please refer to Table 2 below. Compared with the labeling method of AI2, the labeling method of the present disclosure can still maintain an accuracy rate (F1) that is quite close to that of the unlabeled document with the changed order. In contrast to the labeling method of AI2, the unlabeled document with the changed order will greatly reduce the accuracy rate, and it does not have a high tolerance and robustness to the variation of the document structure.

TABLE II

| | Accuracy (%) | |
|---|---|---|
| | Unlabeled | Unlabeled |
| | document | document |
| | with the | with the |
| Labeling | original | changed |
| method | order | order |
| AI2 | 92.9 | 70.0 |
| Present | 96.1 | 96.2 |
| disclosure | | |

According to the above embodiment, the document sentence concept labeling system 100 has a fairly high accuracy and robustness in document structure analysis, and its application in relation extraction and document retrieval can achieve quite good results.

Traditionally, when performing relation extraction, words such as A disease, B gene and C drug can be searched out from the full text of certain documents, and then it is determined that the A disease, the B gene and the C drug are highly related. However, when the C drug is in the sentence set corresponding to the sentence concept of the “background”, the A disease and the B gene are in the sentence set corresponding to the sentence concept of the “contribution”, the C drug is actually not highly related to the A disease and the B gene, resulting in false recognition of relation extraction.

According to the present disclosure, it is possible to limit the search for the sentence set corresponding to the sentence concept of “contribution.” If the A disease, the B gene and the C drug often exist in the sentence set corresponding to the sentence concept of “contribution” in several documents, it can truly confirm that the A disease, the B gene and the C drug are highly related.

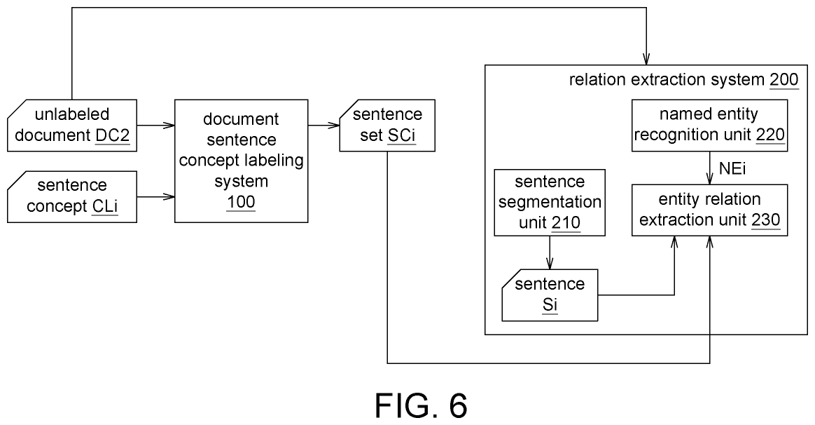

Please refer to FIG. 6, which illustrates a schematic diagram of the document sentence concept labeling system 100 for relation extraction according to an embodiment. The relation extraction system 200 includes a sentence segmentation unit 210, a named entity recognition unit 220 and an entity relation extraction unit 230. The sentence segmentation unit 210, the named entity recognition unit 220 and/or the entity relation extraction unit 230 are/is a circuit, a chip, a circuit board or a storage device for storing program codes.

After the unlabeled document DC2 and the sentence concept CLi are inputted into the document sentence concept labeling system 100, the sentence set SCi can be obtained. The named entity recognition unit 220 generates several entities NEi of the unlabeled document DC2. The sentence segmentation unit 210 generates all the sentences Si in the unlabeled document DC2. The entity relation extraction unit 230 generates entity relation pairs according to whether the entities NEi are existed in the sentence set SCi corresponding to the sentence concept CLi. For example, the medical researchers want to know the entity relation among the A disease, the B gene and the C drug. The entity relation extraction unit 230 will observe whether the entities NEi including the A disease, the B gene and the C drug often appear together in the sentence set SCi corresponding to the specific sentence concept CLi to generate the correct entity relation pairs. That is to say, the relation extraction system 200 can identify whether an entity relation pair holds in the sentence sets SCi corresponding to the sentence concepts CLi in the unlabeled document DC2.

In addition, when searching for documents, the D virus is searched out from certain documents, and then it is determined that these documents are research papers for the D virus. However, when the D virus is in the sentence set corresponding to the sentence concept of the “background”, those documents are probably not researched on the D virus, and search errors occur.

According to the method of this embodiment, the search can be restricted in the sentence set corresponding to the sentence concept of “contribution”, or the sentence set corresponding to the sentence concept of “contribution” can be given a higher search priority, so that the correct document for the D virus can be found.

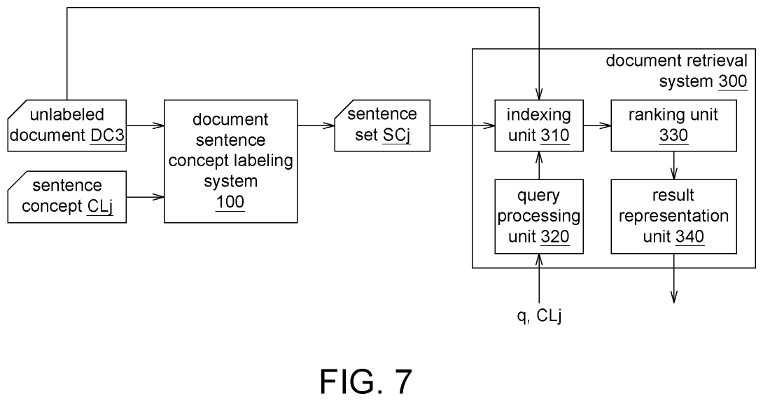

Please refer to FIG. 7, which shows a schematic diagram of the document sentence concept labeling system 100 for document retrieval according to an embodiment. The document retrieval system 300 includes an indexing unit 310, a query processing unit 320, a ranking unit 330 and a result representation unit 340. The indexing unit 310, the query processing unit 320, the ranking unit 330 and/or the result representation unit 340 are/is, for example, a circuit, a chip, a circuit or a storage device storing program codes.

In the indexing phase, an unlabeled documents DC3 are inputted into the indexing unit 310. The indexing unit creates a document index for the unlabeled document DC3.

The document sentence concept labeling system 100 extracts several sentence sets SCj corresponding to the sentence concept CLj for each of the unlabeled documents DC3. The indexing unit 310 creates sub-documents and a sub-document index for the sentence sets SCj.

In the search phase, the query processing unit 320 receives a query condition q and a sentence concept CLj. After the query processing unit 320 generates a search condition, the indexing unit 310 searches in the sub-document index. The sub-documents that meet the search condition are sorted by the ranking unit 330, and the result representation unit 340 gives weighted scores to the sub-documents according to the search condition and returns the search result. That is to say, the document retrieval system 300 can identify whether the query condition q is met based on the sentence sets SCj corresponding to the sentence concepts CLj in the unlabeled document.

According to the above-mentioned embodiment, the document sentence concept labeling system 100 has a fairly high accuracy and robustness in document structure analysis, and its application in relation retrieval and document retrieval can achieve quite good results. Especially in the fields of the technical document analysis, the bidding document analysis, the academic paper analysis and the social opinion analysis, it gives great help.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A training method of a document sentence concept labeling system, comprising:
receiving a plurality of labeled documents, each of which is labeled one or more sentence sets corresponding to one or more sentence concepts;
generating a start position and an end position of each of the sentence sets in each of the labeled documents;
changing orders of the sentence sets in each of the labeled documents, and updating the start positions and the end positions in each of the labeled documents, to obtain a plurality of generated documents, each of which is labeled the sentence sets;
inputting each of the generated documents into a pre-trained language model to obtain a set of word embeddings of each of the generated documents; and
inputting the sets of word embeddings, the start positions and the end positions of the generated documents into a document analysis model for performing a training procedure of the document analysis model, wherein the document analysis model is used to label the sentence concepts in an unlabeled document.

2. The training method of the document sentence concept labeling system according to claim 1, wherein one of the sentence sets contains more than one sentence.

3. The training method of the document sentence concept labeling system according to claim 1, wherein the document analysis model receives full text of the generated documents.

4. The training method of the document sentence concept labeling system according to claim 1, wherein the document analysis model predicts the start positions and the end positions of the sentence sets in the unlabeled document.

5. The training method of the document sentence concept labeling system according to claim 1, wherein the labeled documents are not inputted into the document analysis model, when performing the training procedure.

6. The training method of the document sentence concept labeling system according to claim 1, wherein the pre-trained language model is a BERT model, an ALBERT model, an XLNet model, a RoBERTa model, a DeBERTa model, or a compressed, a simplified or a pruned version of any of the above model.

7. The training method of the document sentence concept labeling system, wherein the document analysis model contains a dense layer and a Softmax layer.

8. A labeling method of a document sentence concept labeling system, comprising:
inputting an unlabeled document and one or more sentence concepts into a pre-trained language model to obtain a set of word embeddings of the unlabeled document;
inputting the set of word embeddings of the unlabeled document into a document analysis model to obtain a start position and an end position of a sentence set corresponding to each of the sentence concepts in the unlabeled document; and
obtaining each of the sentence sets according to each of the start positions and each of the end positions.

9. The labeling method of the document sentence concept labeling system according to claim 8, wherein one of the sentence sets contains more than one sentence.

10. The labeling method of the document sentence concept labeling system according to claim 8, wherein the document analysis model receives full text of the unlabeled document.

11. The labeling method of the document sentence concept labeling system according to claim 8, wherein the pre-trained language model is a BERT model, an ALBERT model, an XLNet model, a RoBERTa model, a DeBERTa model, or a compressed, a simplified or a pruned version of any of the above model.

12. The labeling method of the document sentence concept labeling system according to claim 8, wherein the document analysis model contains a dense layer and a Softmax layer.

13. A document sentence concept labeling system, comprising:
a position indexing unit, configured to receive a plurality of labeled documents, each of which is labeled one or more sentence sets corresponding to one or more sentence concepts, wherein the position indexing unit generates a start position and an end position of each of the sentence sets in the labeled documents;
a data generation unit, configured to change orders of the sentence sets in each of the labeled documents, and update the start positions and the end positions in each of the labeled documents to obtain a plurality of generated documents, each of which is labeled the sentence sets;
a pre-trained language model, configured to obtain a set of word embeddings of each of the generated documents; and
a document analysis model, configured to receive the sets of word embeddings, the start positions and the end positions of the generated documents, for performing a training procedure, wherein the document analysis model is used to label the sentence concepts in an unlabeled document.

14. The document sentence concept labeling system according to claim 13, wherein
the pre-trained language model is further configured to receive the unlabeled document to obtain the set of word embeddings of the unlabeled document,
the document analysis model is further configured to receive the set of word embeddings of the unlabeled document and the sentence concepts, to obtain the start positions and the end positions of the sentence sets corresponding to the sentence concepts.

15. The document sentence concept labeling system according to claim 14, wherein one of the sentence sets contains more than one sentence.

16. The document sentence concept labeling system according to claim 14, wherein the pre-trained language model receives full text of the generated documents.

17. The document sentence concept labeling system according to claim 14, wherein pre-trained language model receives full text of the unlabeled document.

18. The document sentence concept labeling system according to claim 14, wherein the labeled documents are not inputted into the document analysis model, when performing the training procedure.

19. The document sentence concept labeling system according to claim 14, wherein pre-trained language model is a BERT model, an ALBERT model, an XLNet model, a RoBERTa model, a DeBERTa model, or a compressed, a simplified or a pruned version of any of the above model.

20. The document sentence concept labeling system according to claim 14, wherein the document analysis model contains a dense layer and a Softmax.

21. The document sentence concept labeling system according to claim 13, wherein the unlabeled document is inputted into a relation extraction system to identify whether an entity relation pair holds in the sentence sets corresponding to the sentence concepts in the unlabeled document.

22. The document sentence concept labeling system according to claim 13, wherein the unlabeled document is inputted into a document retrieval system to identify whether a query condition is met based on the sentence sets corresponding to the sentence concepts in the unlabeled document.
